(19) United States
(12) Patent Application Publication
(10) Pub. No.: US 2015/0095057 A1
(43) Pub. Date: Apr. 2, 2015

(54) METHODS OF INITIATING A WORKFLOW AND DEVICES THEREOF

(71) Applicant: Health Diagnostic Laboratory, Inc., Richmond, VA (US)

(72) Inventor: J. Michael Woodard, SR., Richmond, VA (US)

(21) Appl. No.: 14/504,105

(22) Filed: Oct. 1, 2014

Related U.S. Application Data
(60) Provisional application No. 61/885,839, filed on Oct. 2, 2013.

(51) Int. Cl. G06F 19/00

(52) U.S. Cl. CPC G06F 19/327; G06F 19/322
USPC 705/2

(57) ABSTRACT

A method for initiating a workflow includes receiving, by a workflow initiation computing device, a patient identifier corresponding to a patient and a patient activity identifier corresponding to a patient activity, wherein the patient activity corresponds to the workflow. A patient activity code is generated based on the received patient identifier and the received patient activity identifier. The generated patient activity code is provided to the patient by at least one of an e-mail, a text message, a website, or an application. An input of the provided patient activity code is received. The workflow is initiated in response to the received input of the patient activity code. A workflow initiation computing device and a non-transitory computer readable medium are also disclosed.

This application claims the benefit of U.S. Provisional Patent Application Ser. No. 61/885,839 filed Oct. 2, 2013 which is hereby incorporated by reference in its entirety.

### BACKGROUND

Many businesses engage in various different workflows including various operational steps. These workflows are often related to an initial interaction with clients or customers. In particular, in the field of health diagnostics, various workflows are related to different interactions with patients to monitor the health of the patient. For example, specific workflows may initiated for laboratory procedures, such as blood draws, or for monitoring and initiating patient wellness activities, such as attending a health seminar or participating in health-related activities, such as running a race or attending a group exercise class. Initiating the workflow often requires interaction with the client or customer to obtain the necessary information related to the specific patient and the related workflow. In particular, the interaction requires establishing what the patient's intentions are within the health diagnostic eco system prior to starting the necessary workflow to fulfil those intentions, resulting in unnecessary delays in initiating the workflow and inefficiencies in completing the workflow. Further, if the client interaction is not received, the workflow will not be initiated, and the patient activity may go unrecognized. These inefficiencies may discourage patients from engaging in important health related services.

The present invention is directed to overcoming these and other deficiencies in the art.

### SUMMARY

One aspect of the invention relates to a method of initiating a workflow including receiving, by a workflow initiation computing device, a patient identifier corresponding to a patient and a patient activity identifier corresponding to a patient activity, wherein the patient activity corresponds to the workflow. A patient activity code is generated based on the received patient identifier and the received patient activity identifier. The generated patient activity code is provided to the patient by at least one of an e-mail, a text message, a website, or an application. An input of the provided patient activity code is received. The workflow is initiated in response to the received input of the patient activity code.

Another aspect of the invention relates to a workflow initiation computing device including a processor coupled to a memory and configured to execute programmed instructions stored in the memory, comprising receiving a patient identifier corresponding to a patient and a patient activity identifier corresponding to a patient activity, wherein the patient activity corresponds to the workflow. A patient activity code is generated based on the received patient identifier and the received patient activity identifier. The generated patient activity code is provided to the patient by at least one of an e-mail, a text message, a website, or an application. An input of the provided patient activity code is received. The workflow is initiated in response to the received input of the patient activity code.

Yet another aspect of the present invention relates to a non-transitory computer readable medium having stored thereon instructions for initiating a workflow comprising machine executable code which when executed by a processor, causes the processor to perform steps including receiving a patient identifier corresponding to a patient and a patient activity identifier corresponding to a patient activity, wherein the patient activity corresponds to the workflow. A patient activity code is generated based on the received patient identifier and the received patient activity identifier. The generated patient activity code is provided to the patient by at least one of an e-mail, a text message, a website, or an application. An input of the provided patient activity code is received. The workflow is initiated in response to the received input of the patient activity code.

The present technology provides a number of advantages, including providing improved methods and devices for workflow initiation. In particular, various embodiments of the present technology provide for streamlined and automatic initiation of a workflow without the need for direct interaction between the client and the business. The present technology allows the client to easily identify their requested services from the business, while at the same time indicating to the business the required services to direct the client/business interaction. In particular, for the health diagnostic field, the present technology facilitates interactions between the patient and the service provider and allows for increased participation in services.

### BRIEF DESCRIPTION OF THE DRAWINGS

FIG. 1 is an environment with an exemplary workflow initiation computing device.

FIG. 2 is a flowchart of an exemplary method for workflow initiation.

### DETAILED DESCRIPTION

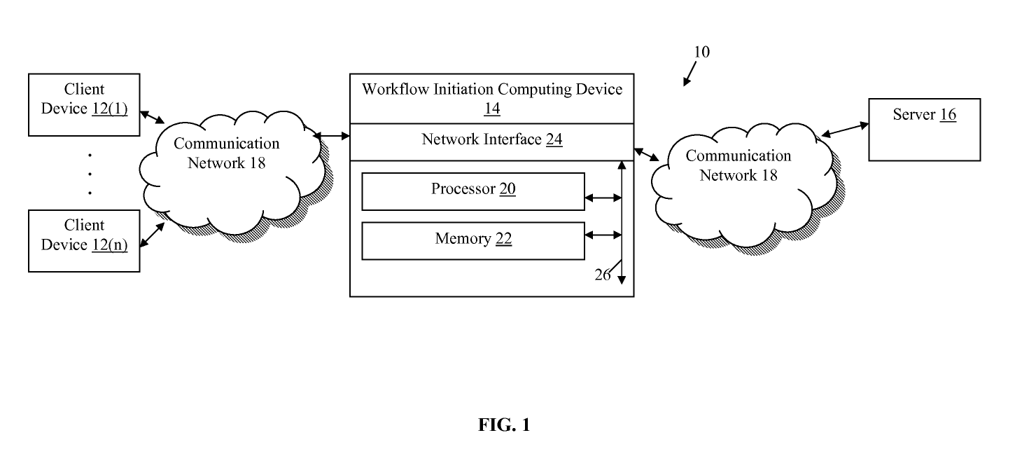

An environment 10 with an exemplary workflow initiation computing device 14 is illustrated in FIG. 1. In this example, the environment 10 includes client devices 12(1)-12(n), the workflow initiation computing device 14, and server 16, which are coupled by communication networks 18, although the environment could include other types and numbers of systems, devices, components, and/or other elements in other configurations and environments with other communication network topologies. This technology provides a number of advantages including providing methods, non-transitory computer readable mediums, and devices for the workflow initiation.

Referring more specifically to FIG. 1, the client devices 12(1)-12(n) enable a user to request and receive information from at least the workflow initiation computing device 14 for the workflow initiation illustrated and described with the examples herein, although the client devices 12(1)-12(n) could perform other types and numbers of functions and other operations. By way of example only, the client devices 12(1)-12(n) may comprise computing devices configured to communicate with the workflow initiation computing device 14 to obtain content, such as one or more web pages or dashboard interfaces, stored at the workflow initiation computing device 14 and/or to send information to the workflow initiation computing device 14.

The client devices 12(1)-12(n) include at least one processor, a memory, a user input device, a display, and a network interface, which are coupled together by a bus or other link, although one or more of client devices 12(1)-12(n) can include other numbers and types of components, parts, devices, systems, and elements in other configurations. The processor in each of the client devices 12(1)-12(n) can execute programmed instructions stored in the memory of each of the client devices 12(1)-12(n) for one or more aspects of the present invention as described and illustrated herein, although the processors could execute other numbers and types of programmed instructions.

The memory in each of the client devices 12(1)-12(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in the client devices 12(1)-12(n).

The user input device in each of the client devices 12(1)-12(n) can be used to input selections, such as a request for content or information from the workflow initiation computing device 14, although the user input devices could be used to input other types of requests and data. The user input devices can include keypads or touch screens although other types and numbers of user input devices can be used. The display in each of the client devices 12(1)-12(n) can be used to show data and information to the user, such as a dashboard interface, in response to a request for the information from the workflow initiation computing device 14. The network interface in each of the client devices 12(1)-12(n) can be used to operatively couple and communicate between the client devices 12(1)-12(n) and at least the workflow initiation computing device 14 via the communication network 18.

The workflow initiation computing device 14 includes at least one processor 20, a memory 22, and a network interface 24, which are coupled together by a bus 26 or other link, although other numbers and types of components, parts, devices, systems, and elements in other configurations and locations can be used. The processor 20 in the workflow initiation computing device 14 executes a program of stored instructions for one or more aspects of the present invention as described and illustrated by way of the embodiments herein, although the processor 20 could execute other numbers and types of programmed instructions.

The memory 22 in the workflow initiation computing device 14 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 20, can be used for the memory 22 in the workflow initiation computing device 14.

The network interface 24 in the workflow initiation computing device 14 is used to operatively couple and communicate between the workflow initiation computing device 14 and the client devices 12(1)-12(n) and the physician devices 16(1)-16(n) via the communication networks 18, although other types and numbers of communication networks 18 with other types and numbers of connections and configurations can be used. Additionally, the communication networks 18 can include one or more local area networks (LANs) and/or wide area networks (WANs). By way of example only, the communication networks can use TCP/IP over Ethernet and industry-standard protocols, including hypertext transfer protocol (HTTP) and/or secure HTTP (HTTPS), for example, although other types and numbers of communication networks also can be used.

The server 16 includes at least one processor, a memory, and a network interface configured to communicate with the workflow initiation computing device 14 via communication network 18, although the server 16 could have other numbers and types of components, parts, devices, systems, and elements in other configurations and locations.

Although embodiments of the workflow initiation computing device 14, the client devices 12(1)-12(n), and server 16 are described and illustrated herein, each of the workflow initiation computing device 14, the client devices 12(1)-12(n), and server 16 can be implemented on any suitable computer apparatus or computing device. It is to be understood that the apparatuses and devices of the embodiments described herein are for exemplary purposes, as many variations of the specific hardware and software used to implement the embodiments are possible, as will be appreciated by those skilled in the relevant art(s).

Furthermore, each of the devices of the embodiments may be conveniently implemented using one or more general purpose computers, microprocessors, digital signal processors, and micro-controllers, programmed according to the teachings of the embodiments, as described and illustrated herein, and as will be appreciated by those ordinary skill in the art.

The embodiments may also be embodied as one or more non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

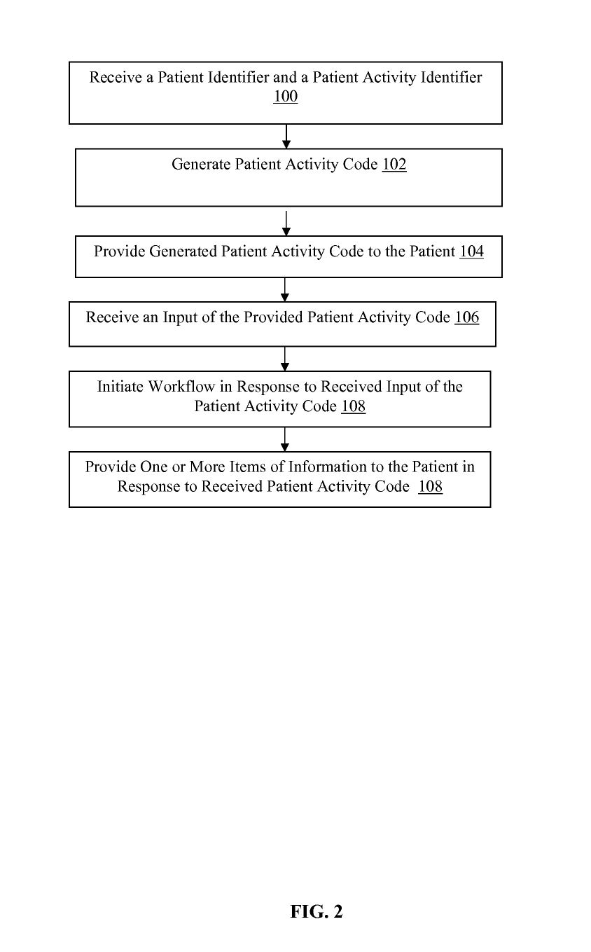

An example of a method of initiation a workflow will now be described with reference to FIGS. 1 and 2. Referring more specifically to FIG. 2, an exemplary method for the initiation of a workflow is illustrated. In step 100, the workflow initiation computing device 14 receives a patient identifier corresponding to a patient and a patient activity identifier corresponding to a patient activity. The patient activity corresponds to the workflow to be initiated.

The patient identifier is a unique identifier or code related the identity of the patient, such as a patient identification number, although other identifiers that indicate the specific patient's identify may be utilized. In one example, the patient identifier is the patient's name and other identifying information such as a birth date or social security number. A patient identification code associated with the patient is then received from server 16 based on the received patient identifiers. In this example, server 16 includes a database correlating the received patient identifiers with the patient identification code.

The patient activity identifier is a unique identifier or code related to a specific patient activity. In one example, the patient activity identifier corresponds to the patient activity of going to have blood drawn at a blood draw facility and the related workflow is a laboratory diagnostic workflow of collecting and analyzing the blood sample, although other patient activity identifiers corresponding to patient wellness activities such as, by way of example only, attending a sponsored wellness activity, such as a wellness seminar, class participation, attending an appointment for treatment such as for quitting smoking, taking a tour for health improvement, attending other health counseling, attending a sponsored or affiliated running race such as a marathon or 5 k, attending independent or group exercise sessions such as yoga, spinning, or pilates, related to other associated workflows, may be received. In one embodiment, the patient activity identifier is related to one patient activity, although the patient activity identifier may be related to two or more patient activities.

The patient identifier and patient activity identifier are received from one of the client devices 12(1)-12(n), although the patient identifier and patient activity identifier may be received in other manners from other locations, such as being input directly into workflow initiation computing device 14, or from server 16. In one embodiment, the workflow initiation computing device 14 provides a list of patient activities for display on a display interface of one of client devices 12(1)-12(n) for user selection. By way of example, client device 12(1) may be located in a physician's office and provide a list of available patient activities related to health diagnostic services, such as obtaining a blood draw. In this example, the physician selects the blood draw activity for a particular patient and the workflow initiation computing device 14 receives the assigned patient activity based on the physician's selection. In another example, the workflow initiation computing device 14 displays a list of available health seminars or group exercise classes which may be selected by a user, although the workflow initiation computing device may provide other lists of activities for display and user selection on one the client devices 12(1)-12(n).

In step 102, the workflow initiation computing device 14 generates a patient activity code based on the received patient identifier and the received patient activity identifier. The generated patient activity code stores information related to both the patient's identity and the selected patient activity. By way of example, the patient activity code may be a quick response code that indicates a particular patient is scheduled for a blood draw, although other patient activity codes such as alphanumeric keys or url's, by way of example only, may be utilized to store information related to other patients and any other patient activities.

Next, in step 104, the workflow initiation computing device 14 provides the generated patient activity code to the patient associated with the patient identifier. In one embodiment, the generated patient activity codes is provided to one of the client computing devices 12(1)-12(n) via e-mail, although other transmission methods may be utilized, such as text message. Alternatively, the generated patient activity code may be accessible to the patient on a website or an application accessible through the one of the client devices 12(1)-12(n).

In step 106, the workflow initiation computing device 14 receives an input of the provided patient activity code. In one example, the workflow initiation computing device 14 receives the input of a quick response code through a quick response code reader operatively coupled to the workflow initiation computing device 14, although the workflow initiation computing device 14 may receive the input of the provided patient activity code in other manners, such as through a patient kiosk operatively coupled to the workflow initiation computing device, or by a direct input into the workflow initiation computing device 14, such as through an alphanumeric key.

In step 108, the workflow initiation computing device 14 initiates the workflow in response to the received input of the patient activity code. In one example, the workflow initiation computing device 14 initiates a workflow for a diagnostic laboratory test such a blood draw, although other diagnostic laboratory workflows may be initiated. In this example, initiating the workflow includes providing an alert to the phlebotomist that the patient has arrived for the blood draw, as well as initiating other preparatory steps to streamline the workflow. In another example, the initiation includes initiating a wellness workflow such a wellness activity, an appointment for treatment, health counseling, a running race, or an exercise session. Initiating the workflow may include registering the patient for the patient activity, such as a health seminar, a group exercise class, or a running race, by way of example only. The workflow initiation computing device 14 may further provide an alert indicating that the workflow has been initiated on one of the client computing devices 12(1)-12(n).

In step 110, the workflow initiation computing device 14 provides one or more items of information to the patient in response to the received patient activity code. In one example, the one or more items of information include informational materials regarding the workflow, such as additional informational material regarding the content to be presented at a health seminar. Alternatively, the information may be additional questions directed to the patient, such as to collect additional biographical information prior to a blood draw. The information may be provided to one of the client devices 12(1)-12(n), although the information may be provided to other locations, such as a patient kiosk communicatively coupled to the workflow initiation computing device 14.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method of initiating a workflow comprising:
receiving, by a workflow initiation computing device, a patient identifier corresponding to a patient and a patient activity identifier corresponding to a patient activity, wherein the patient activity corresponds to the workflow;
generating, by the workflow initiation computing device, a patient activity code based on the received patient identifier and the received patient activity identifier;
providing, by the workflow initiation computing device, the generated patient activity code to the patient by at least one of an e-mail, a text message, a website, or an application;
receiving, by the workflow initiation computing device, an input of the provided patient activity code; and
initiating, by the workflow initiation computing device, the workflow in response to the received input of the patient activity code.

2. The method of claim 1 wherein receiving the patient activity identifier further comprises:
providing, by the workflow initiation computing device, a list of patient activities; and
receiving, by the workflow initiation computing device, the patient activity based on a user selection from the list of patient activities.

3. The method of claim 1 wherein the patient activity code comprises at least one of a quick response code, an alphanumeric key, or a url.

4. The method of claim 1 wherein the workflow comprises a wellness program workflow.

5. The method of claim 4 wherein the wellness workflow comprises a patient blood draw, a wellness activity, an appointment for treatment, health counseling, a running race, or an exercise session.

6. The method of claim 1 wherein the initiating the workflow further comprises:
registering, by the workflow initiation computing device, the patient for the activity; and
providing, by the workflow initiation computing device, an alert indicating the initiation of the workflow.

7. The method of claim 1 further comprising:
providing, by the workflow initiation computing device, one or more items of information to the patient in response to the received patient activity code.

8. The method of claim 7 wherein the one or more items of information are provided at a patient kiosk.

9. A workflow initiation computing device, comprising:
a processor coupled to a memory and configured to execute programmed instructions stored in the memory, comprising:
receiving a patient identifier corresponding to a patient and a patient activity identifier corresponding to a patient activity, wherein the patient activity corresponds to the workflow;
generating a patient activity code based on the received patient identifier and the received patient activity identifier;
providing the generated patient activity code to the patient by at least one of an e-mail, a text message, a website, or an application;
receiving an input of the provided patient activity code; and
initiating the workflow in response to the received input of the patient activity code.

10. The device of claim 9 wherein receiving the patient activity identifier further comprises:
providing a list of patient activities; and
receiving the patient activity based on a user selection from the list of patient activities.

11. The device of claim 9 wherein the patient activity code comprises at least one of a quick response code, an alphanumeric key, or a url.

12. The device of claim 9 wherein the workflow comprises a wellness workflow.

13. The method of claim 12 wherein the wellness workflow comprises a patient blood draw, a wellness activity, an appointment for treatment, health counseling, a running race, or an exercise session.

14. The device of claim 9 wherein the initiating the workflow further comprises:
registering the patient for the activity; and
providing an alert indicating the initiation of the workflow.

15. The device of claim 9 wherein the processor is further configured to execute programmed instructions stored in the memory further comprising:
providing, by the workflow initiation computing device, one or more items of information to the patient in response to the received patient activity code.

16. The device of claim 15 wherein the one or more items of information are provided at a patient kiosk.

17. A non-transitory computer readable medium having stored thereon instructions for initiating a workflow comprising machine executable code which when executed by a processor, causes the processor to perform steps comprising:
receiving a patient identifier corresponding to a patient and a patient activity identifier corresponding to a patient activity, wherein the patient activity corresponds to the workflow;
generating a patient activity code based on the received patient identifier and the received patient activity identifier;
providing the generated patient activity code to the patient by at least one of an e-mail, a text message, a website, or an application;
receiving an input of the provided patient activity code; and
initiating the workflow in response to the received input of the patient activity code.

18. The medium of claim 17 wherein receiving the patient activity identifier further comprises:
providing a list of patient activities; and
receiving the patient activity based on a user selection from the list of patient activities.

19. The medium of claim 17 wherein the patient activity code comprises at least one of a quick response code, an alphanumeric key, or a url.

20. The medium of claim 17 wherein the workflow comprises a wellness workflow.

21. The medium of claim 20 wherein the wellness workflow comprises a patient blood draw, a wellness activity, an appointment for treatment, health counseling, a running race, or an exercise session.

22. The medium of claim 17 wherein the initiating the workflow further comprises:
registering the patient for the activity; and
providing an alert indicating the initiation of the workflow.

23. The medium of claim 17 wherein the wherein the medium further comprises machine executable code which, when executed by the processor, causes the processor to perform steps further comprising:
providing, by the workflow initiation computing device, one or more items of information to the patient in response to the received patient activity code.

24. The medium of claim 23 wherein the one or more items of information are provided at a patient kiosk.
